(19) United States
(12) Patent Application Publication
(10) Pub. No.: US 2013/0018572 A1
(43) Pub. Date: Jan. 17, 2013

(54) APPARATUS AND METHOD FOR CONTROLLING VEHICLE AT AUTONOMOUS INTERSECTION

(71) Applicant: Jeong-Ah JANG, Daejeon (KR)

(72) Inventor: Jeong-Ah JANG, Daejeon (KR)

(73) Assignee: ELECTRONICS AND TELECOMMUNICATIONS RESEARCH INSTITUTE, Daejeon-City (KR)

(21) Appl. No.: 13/545,432

(22) Filed: Jul. 10, 2012

(30) Foreign Application Priority Data
Jul. 11, 2011 (KR) 10-2011-0068267

(51) Int. Cl. G08G 1/00; G08G 1/16

(52) U.S. Cl. 701/119; 701/117

(57) ABSTRACT

Disclosed herein are an apparatus and method for controlling traffic at an autonomous intersection. A monitoring unit monitoring vehicles located within a predetermined service radius of an intersection. A collision zone information management unit classifies the service radius into a plurality of zones based on the results from the monitoring unit, and manages information about collision zones. A collision prediction unit predicts the possibility of collision of a target vehicle in the zone in which the target vehicle is located, based on vehicle information transmitted from the target vehicle, and calculates an estimated time of collision. A priority determination unit predetermines a priority of the target vehicle based on the estimated time of collision and calculates an expected entering time corresponding to the priority. A communication unit transmits control information about the target vehicle to the corresponding vehicles to control respective vehicles.

### CROSS REFERENCE TO RELATED APPLICATION(S)

This application claims the benefit of Korean Patent Application No. 10-2011-0068267, filed on Jul. 11, 2011, which is hereby incorporated by reference in its entirety into this application.

### BACKGROUND OF THE INVENTION

1. Technical Field

The present invention relates generally to an apparatus and method for controlling a vehicle at an autonomous intersection and, more particularly, to an apparatus and method for controlling traffic at an autonomous intersection without using traffic signal lamps or traffic signs such as YIELD sign and STOP sign.

2. Description of the Related Art

In advanced highway and vehicle systems (AHVS) or future roads which are adapted for unmanned vehicles, the essential elements are vehicles traveling on the roads and a server that monitors and controls traffic. Here, a system in a vehicle (also referred hereinafter to as a “vehicle system”) and a server external to a vehicle perform the mutual real-time exchange of information using a continuous, uninterruptible wireless communication infrastructure, and smoothly control traffic based on this action, avoiding traffic accidents.

Particularly, autonomous drive management systems are epoch-making systems that can support the driving of unmanned vehicles. For example, if autonomous traffic management is performed at an intersection where traffic congestion may occur in various directions, the traffic can be autonomously controlled for those directions without the aid of traffic lamps or separate traffic signs.

Generally, at a street intersection, there are traffic lamps in all directions so that they assign the priority of travel to respective vehicles that enter the intersection using their traffic lights (using red, yellow, and green colors) in order to control traffic. Among traffic lights, a green color is the signal that allows for the traveling of vehicles, a yellow color is the signal that indicates a lag time between the light changing from green to red, and the red color is the signal that stops the traveling of vehicles.

Despite the restrictions applied by such traffic lamps, many traffic accidents occur at intersections because of traffic signal violations. In addition, at intersections, due to unnecessary long signals and the display system, additional traffic congestion may also occur and the driver is confused.

One way to reduce the traffic congestion at the intersection is to construct an underpass or overpass at great expense so as to reduce the possibility of traffic accidents at the intersection. Such a method, however, has economical problems when the road structure is altered.

In the related art, for instance, there have been proposed a system which reduces the possibility of traffic accidents at an intersection and determines traffic safety (Korean Unexamined Patent publication No. 10-2009-0130977); an autonomous vehicle signal-priority system which assigns traffic signal priority to an autonomous vehicle at an intersection, compared to other vehicles to allow the autonomous vehicle to travel first (Korean Unexamined Patent publication No. 10-2010-0036832); an active safety drive support system at an intersection (Korean Unexamined Patent publication No. 10-2010-0070163); an anti-collision system for a vehicle (Korean Unexamined Patent publication No. 10-2009-0063002); and the like.

However, such conventional systems have limitations as far as checking the possibility of a collision for each vehicle at a signal-less intersection and setting information about a driver or allowing for autonomous driving of a vehicle based on the results of checking.

### SUMMARY OF THE INVENTION

Accordingly, the present invention has been made keeping in mind the above problems occurring in the related art, and an object of the present invention is to provide an apparatus and method for controlling traffic at an autonomous intersection without using traffic lamps or traffic signs.

In order to accomplish the above object, in an aspect, the present invention provides an apparatus for controlling traffic at an autonomous intersection, the apparatus including: a monitoring unit for tracking vehicles located within a predetermined service radius of an intersection; a collision zone information management unit for classifying a region within the service radius into a plurality of zones depending on a set reference based on the result from the monitoring unit, and managing information about collision zones corresponding to the plurality of classified zones; a collision prediction unit for predicting the possibility of colliding of a target vehicle in the zone in which the target vehicle is located, based on vehicle information transmitted from the target vehicle located within the service radius, and calculating an estimated time of collision corresponding to the predicted result; a priority determination unit for predetermining a priority of the target vehicle based on the estimated time of collision and calculating an expected entering time corresponding to the priority; and a communication unit transmitting for control information of the target vehicle, including the identifications, the expected entering time, a warning or a control mode corresponding to the expected entering time, to the target vehicle to control the target vehicle.

The collision zone information management unit may be configured to classify the service radius of the intersection into a central zone of the intersection, a proximal zone of the intersection, and a controllable zone, depending on the set reference corresponding to whether able to autonomously control vehicles passing through the intersection or not.

The central zone of the intersection may be a zone through which vehicles in all directions of the intersection pass, the proximal zone of the intersection may be a zone established based on the autonomous control of vehicles, and the controllable zone may be a zone in which a warning message is transmitted to a driver to control vehicles.

The collision prediction unit may be configured to estimate the traveled positions of the target vehicle that are traveling using a current speed and a user set time among vehicle information and calculate a distance between a vehicle ahead and a vehicle behind in each direction of the intersection depending on the difference in positions of vehicles so as to calculate the estimated time of collision taken from the traveled position to the central zone of the intersection.

The estimated time of collision may be calculated based on the distance between the traveled position and the central zone of the intersection among the plurality of zones, and the speed of the target vehicle.

The priority determination unit may be configured to set the number of vehicles entering the central zone of the intersection to be different in conformity with the magnitude of the central zone of the intersection among the plurality of zones and assign the number of priorities corresponding to the number of the vehicles that was set.

The communication unit may be configured to transmit control information about the target vehicle to the target vehicle via wireless communication.

In another aspect, the present invention provides a method of controlling traffic at an autonomous intersection, the method including:

Monitoring vehicles located within a predetermined service radius of an intersection; classifying the service radius into a plurality of zones depending on a set reference based on the monitored result, and managing information about collision zones corresponding to the plurality of classified zones; predicting the possibility of colliding of a target vehicle in the zone at which the target vehicle is located, based on vehicle information transmitted from the target vehicle located within the service radius, and calculating an estimated time of collision corresponding to the predicted result; predetermining a priority of the target vehicle based on the estimated time of collision and calculating an expected entering time corresponding to the priority; and controlling the vehicles based on the control information about the target vehicle, including the identifications, the expected entering time, and a warning or control mode corresponding to the expected entering time.

Managing the information about the collision zones may include classifying the service radius of the intersection into a central zone of the intersection, a proximal zone of the intersection, and a controllable zone, depending on the set reference corresponding to whether it is able to autonomously control vehicles passing through the intersection or not.

The central zone of the intersection may be a zone through which vehicles in all directions of the intersection pass, the proximal zone of the intersection may be a zone established based on the autonomous control of vehicles, and the controllable zone may be a zone in which a warning message is transmitted to a driver to control vehicles.

Calculating the estimated time of collision may include estimating the traveled positions of the target vehicle that are traveling, using a current speed and a user set time among vehicle information; calculating the distance between a vehicle ahead and a vehicle behind in each direction of the intersection depending on the difference in positions of vehicles; and calculating the estimated time of collision taken from the traveled position to the central zone of the intersection.

The estimated time of collision may be calculated based on a distance between the traveled position and the central zone of the intersection among the plurality of zones, and the speed of the target vehicle.

Calculating the expected entering time may include setting the number of vehicles entering the central zone of the intersection to be different in conformity with the magnitude of the central zone of the intersection among the plurality of zones; and assigning the number of priorities corresponding to the number of the vehicles that was set.

In an apparatus and method for controlling traffic at an autonomous intersection according to the embodiments of the present invention, the priority at which vehicles at the intersection can enter the intersection are given without using traffic lamps so that autonomous driving can be managed, by way of real-time communication between the internal devices of vehicles and a controller for vehicles on intelligent roads combined with information technology (IT).

Further, in an apparatus and method for controlling traffic at an autonomous intersection according to the embodiments of the present invention, without using traffic signals or traffic signs, the entering of vehicles into an intersection may be controlled by a driver who has been warned by an autonomous system, or otherwise the direction and speed thereof may be controlled directly by the autonomous system, depending on positions and traveling conditions of vehicles, thereby smoothly controlling traffic and preventing possible collisions at the intersection.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view showing the environment of an autonomous intersection which has been adapted to a vehicle controller according to an embodiment of the present invention;

FIG. 2 is a block diagram of the vehicle controller;

FIG. 3 is a block diagram of an internal device of a vehicle;

FIG. 4 is a flow chart showing a procedure of a method of controlling traffic at an autonomous intersection according to an embodiment of the present invention;

FIG. 5 is a view showing collision zones at an intersection according to an embodiment of the present invention; and

FIG. 6 is a flow chart showing a procedure for predicting the possibility of colliding of a target vehicle at the autonomous intersection according to an embodiment of the present invention.

### DESCRIPTION OF THE PREFERRED EMBODIMENTS

Hereinbelow, preferred embodiments of the present invention will be described in detail with reference to the accompanying drawings. In the following description, it is to be noted that, when the functions of conventional elements and the detailed description of elements related to the present invention may make the gist of the present invention unclear, a detailed description of those elements will be omitted. The embodiment of the present invention described hereinbelow is provided to allow those skilled in the art to more clearly comprehend the present invention. Therefore, it should be understood that the shape and size of the elements shown in the drawings may be exaggerated in the drawings to provide an easily understood description of the structure of the present invention.

A detailed description will now be made of an apparatus and method for controlling traffic at an autonomous intersection according to embodiments of the present invention with reference to the accompanying drawings.

First, an intersection is a place, such as a forked road, a four-way stop, a rotary circle, a crossroad, etc. where there are two main roads which meet or cross.

An autonomous driving system adapted to the present invention is, but is not limited to, a system wherein when a vehicle is traveling through an intersection, the vehicle perceives the surrounding environment based on acquisition of information about its surroundings and by means of a processing function thereof so as to determine a traveling path and then travels therealong using its own power in an autonomous manner.

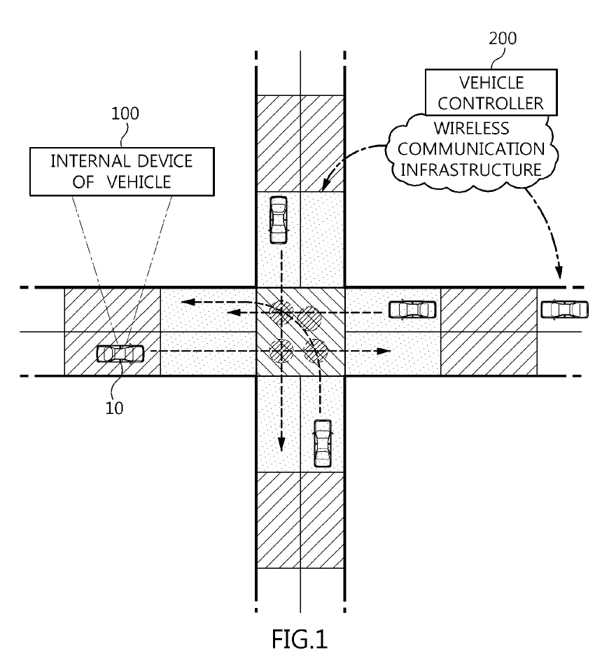

FIG. 1 is a view showing the environment of an autonomous intersection which has been adapted to a vehicle controller according to an embodiment of the present invention.

Referring to FIG. 1, the environment of an intersection according to an embodiment includes at least one vehicle 10, an internal device 100 of the vehicle, and a vehicle controller 200 which is provided at the intersection locally or at a main processing center such as traffic central center. Here, a wireless communication infrastructure is constructed between the internal device 100 and the controller 200. The wireless communication infrastructure may employ any wireless communication method. However, embodiments assume that the wireless communication infrastructure is a communication medium that ensures the real-time features that are required by a user (also referred hereinafter to as a “driver”), and has real-time operability and high reliability.

The internal device 100 of a vehicle senses in real time the position and speed of the vehicle 10, receives the sensed result, i.e. the control information of a vehicle corresponding to vehicle information, from the vehicle controller 200, and warns a driver to prompt the driver to control the vehicle, or controls the direction and speed of the vehicle, based on the control information of the vehicle.

The vehicle controller 200 is designed to monitor in real time vehicles within a service radius via a wireless communication infrastructure, and classify an intersection into a plurality of collision zones based on the results of the monitoring. Next, the vehicle controller 200 generates control information of a vehicle including a possibility of vehicles colliding with other vehicles, an estimated time of collision, vehicle-priorities, an expected entering time, a warning, a control mode, etc. of vehicles located at collision zones corresponding to the vehicle information transmitted from the internal devices 100 of vehicles.

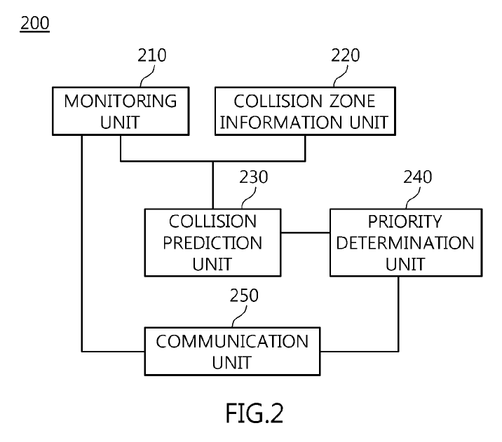

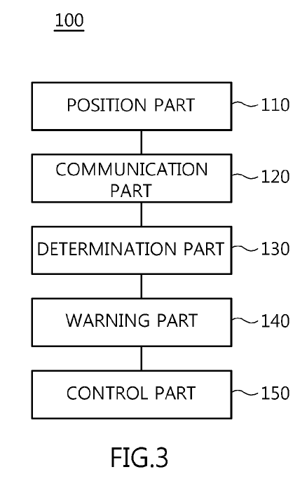

Next, the internal device 100 of a vehicle and the vehicle controller 200 will be described in detail with reference to FIGS. 2 and 3.

FIG. 2 is a block diagram of the vehicle controller, and FIG. 3 is a block diagram of the internal device of a vehicle.

First, the vehicle controller 200 is located at an intersection or at a main control center in order to generally control traffic at unitary or plural intersections without using traffic lamps or traffic signs.

Referring to FIG. 2, the vehicle controller 200 includes a monitoring unit 210, a collision zone information management unit 220, a collision prediction unit 230, a priority determination unit 240, and a communication unit 250.

The monitoring unit 210 is designed to monitor vehicles within a predetermined service radius of an intersection.

The collision zone information management unit 220 is configured to classify a region within the service radius including the intersection into a plurality of zones depending on a set reference based on the result of monitoring, and manage information about collision zones respectively corresponding to the plurality of classified zones. Here, the set reference corresponds to whether able to autonomously control vehicles passing through the intersection, or not.

The collision zone information management unit 220 classifies the region within the service radius into a central zone of the intersection through which vehicles in all directions of the intersection pass, a proximal zone of the intersection that is based on autonomous control of vehicles, and a controllable zone in which a warning message is transmittable to a driver to control vehicles, depending on the set reference.

The collision prediction unit 230 is configured to predict the possibility of collision at collision zones at which vehicles corresponding to the vehicle information transmitted from the internal devices 100 are located, and calculate information about the possibility of collision corresponding to the results of the prediction. Here, the information about the possibility of collision includes vehicle information (the identification (ID), advancing direction, position, and speed of a vehicle 10), a collision zone, the distance from a following vehicle to the rear, and an estimated time of collision (also referred to as “TTC”).

Specifically, the collision prediction unit 230 predicts the positions of vehicles at every user-setting time (e.g. 1, 2, 3 seconds) for vehicles and directions based on the vehicle information. Here, the vehicle information includes an ID, information about the advancing direction, a position [e.g. a coordinate value such as (x, y)], and the speed of a vehicle 10. Here, the information about the advancing direction may indicate e.g. at least one of east-entering, west-entering, south-entering, and north-entering at a 4-way crossroad. That is, a respective vehicle should previously have the information about the direction in which it is traveling. Respective vehicle can determine both its own entering position and its turning to the left or right, or its driving straight, based on the information about the advancing direction.

The collision prediction unit 230 can predict the traveled positions of vehicles that are traveling by using the current speed and a user-setting time among vehicle information per the following Equation 1.

Traveled Position=Current Speed*User-setting Time Equation 1

Next, the collision prediction unit 230 calculates the distance between a vehicle to the front and a vehicle to the rear depending on the difference in the positions of the vehicles in each direction. Further, the collision prediction unit 230 calculates the time from the traveled positions of vehicles that were calculated for vehicles and directions to the central zone of the intersection, i.e. the estimated time of collision (TTC). Here, the TTC is calculated based on the distance between the traveled position of a vehicle and the central zone of the intersection, and a speed of the target vehicle.

The priority determination unit 240 predetermines vehicles-priorities based on the estimated time of collision. Here, the priority determination unit sets the number of vehicles located at the central zone of the intersection to be different in conformity with the magnitude of the central zone of the intersection and assigns the number of priorities corresponding to the number of the vehicles that was set.

Next, a method of assigning the priority sequence will be described with respect to a first case of an intersection being the crossing of two one-lane roads and a second case of an intersection being the crossing of a multi-lane road and another multi-lane road.

First Case

The priority determination unit 240 is designed such that if it sets the number of vehicles that enter a region of a one-by-one intersection, to two, it assigns priorities to the two vehicles that have a short TTC.

The priority determination unit 240 determines whether vehicles other than those assigned with priorities are located at proximal zones of the intersection or controllable zones, or not, and establishes a warning mode or a control mode based on the determined result. That is, the priority determination unit 240 does not assign priorities for the vehicles other than the two vehicles assigned with the priorities.

The priority determination unit 240 establishes the expected time to enter the intersection for the vehicles assigned with priorities according to the IDs of the vehicles.

Second Case

The priority determination unit 240 is designed such that in case of an intersection being a crossroads having multi-lanes in each direction, it assigns priority to vehicles entering that intersection, taking into account the kinds of advancing-direction indicating lanes in which the vehicles are located, such as a left-turning lane, a right-turning lane, or the straight-driving lane and the possibility of vehicles traveling along the lanes to suit their advancing directions. For instance, the priority determination unit 240 assigns priority to the vehicle driving straight among all vehicles including among those entering from the east, west, south, and north, in correspondence with the expected entering time thereof. On the contrary, the priority determination unit 240 also assigns the same priorities to the vehicle entering from the south and then turning to the left and the vehicle entering from east and then turning to the right, because both vehicles do not meet at the intersection.

Like this, the priority determination unit 240 assigns the priorities for respective lanes, directions, and vehicles, and stores them.

The communication unit 250 receives vehicle information from the internal device 100 of at least one vehicle 10, and transmits the control information of a vehicle corresponding to the vehicle information to the internal device 100. Here, the vehicle information includes the ID of a vehicle, an expected entering time, a warning, or a control mode.

Referring to FIG. 3, the internal device 100 includes a position sensor part 110, a communication part 120, a determination part 130, a warning part 140, and a control part 150.

The position sensor part 110 includes a sensor to detect the position of a vehicle, and converts the sensed result to generate position data.

The communication part 120 performs communication with the vehicle controller 200.

Specifically, the communication part 120 transmits vehicle information including the IDs of the corresponding vehicles 10, the position and speed of the vehicles, which are generated by the position sensor part 110, and the like, and receives control information about the vehicles corresponding to the vehicle information. Here, the form of the position data of the vehicle may be that of absolute coordinates including the longitude and latitude of the position of a vehicle, or relative coordinates which are relative to a certain region.

The determination part 130 determines whether to send a warning to a vehicle, which control mode is used to control the vehicle, or whether the vehicle has entered the intersection or not, based on the control information of a vehicle which was transmitted from the vehicle controller 200. For instance, the determination part 130 determines whether to send a warning message to a driver or to control the driving of the corresponding vehicle, based on the control information of the vehicle.

The warning part 140 transmits a warning message to the driver of a corresponding vehicle based on the determination results of the determination part 130. Here, the warning part 140 may transmit the warning message by means of, but is not limited to, a display such as a navigation system equipped in the vehicle.

The control part 150 controls the direction and speed of the vehicle based on the determined result of the determination part 130.

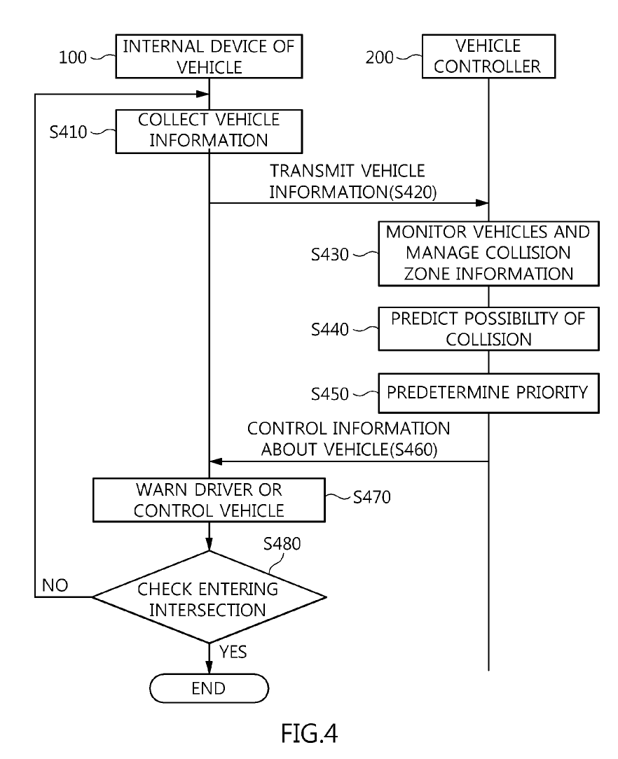

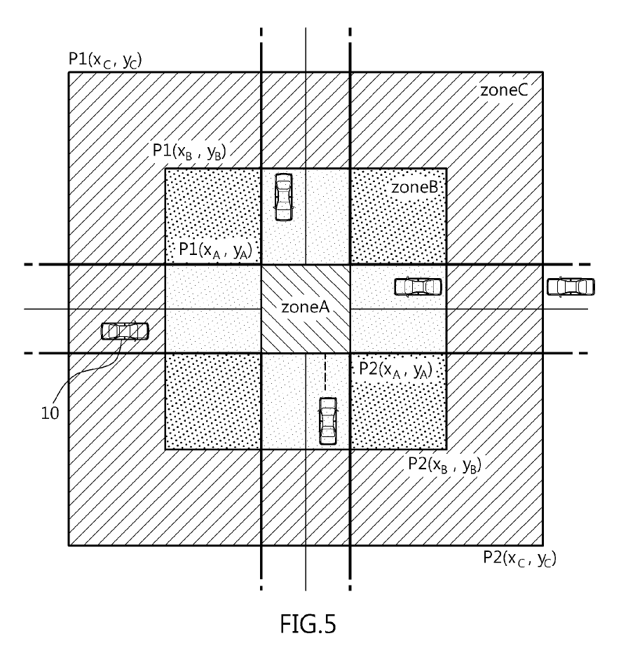

Next, a method of controlling the traffic at an autonomous intersection will be described in detail with reference to FIGS. 4 and 5.

FIG. 4 is a flow chart showing a procedure of the method of controlling traffic at the autonomous intersection according to an embodiment of the present invention, and FIG. 5 is a view showing collision zones at the intersection according to an embodiment of the present invention.

The environment adapted to the method of controlling traffic at the autonomous intersection according to the present invention includes at least one vehicle 10, an internal device 100 installed in a vehicle, and a vehicle controller 200 located at the intersection or at a main processing center.

Referring to FIG. 4, the internal device 100 of a vehicle senses the vehicle so as to collect vehicle information including a position, a speed, etc. of the sensed vehicle (S410). Here, the form of the position data of the vehicle may be that of absolute coordinates including the longitude and latitude of the position of a vehicle, or relative coordinates which are relative to a certain region.

The internal device 100 transmits the vehicle information, which was collected, to the vehicle controller 200 via wireless communication (S420).

The vehicle controller 200 monitors vehicles located within a predetermined service radius from an intersection, classifies the service radius including the intersection into a plurality of zones depending on a set reference based on the results of monitoring, and manages information about collision zones corresponding to the plurality of zones (S430). Here, the set reference corresponds to whether able to autonomously control vehicles that are traveling across the intersection, or not.

Referring to FIG. 5, the vehicle controller 200 classifies the region within the service radius into a central zone (zone A) of the intersection through which vehicles in all directions of the intersection pass, a proximal zone (zone B) of the intersection that is based on autonomous control of vehicles, and a controllable zone (zone C) in which a warning message is transmitted to a driver to control vehicles, depending on the set reference.

The central zone (zone A) of the intersection generally corresponds to the inside region which is defined by stop lines of crosswalks in all the directions of an intersection. The zone A is a fixed zone which is physically set depending on the shape and size of the intersection. For instance, the zone A may be a zone which has the shape of a rectangular polygon within the service radius and is defined by two points [P1(x_{A}, y_{A}) and P2(x_{A}, y_{A})].

The proximal zone B of the intersection is a zone in which even when a driver is warned so as to slow down a vehicle, the vehicle cannot avoid colliding with another object. Thus, in the zone B, a vehicle is guided to drive at a certain speed or less, and the vehicle can be controlled to accelerate or decelerate according to the status of priority of the vehicle. Thus, the size of the proximal zone B of the intersection corresponds to a linear function between the average speed and the estimated duration time (T2) to control the vehicle. Here the estimated duration time (T2) is expressed by the following Equation 2.

Estimated Duration Time (T2) to Control Vehicle=Communication Time (time of transmission and reception)+Information Processing Time of Vehicle Controller 200 and Internal Device 100+Duration Time to Perform Controlling Vehicle+Safety Critical Time Equation 2

In Equation 2, the safety critical time corresponds to a predetermined time set by the vehicle controller 200.

For instance, the proximal zone B of the intersection may be a zone which has the shape of a rectangular polygon and is defined by two points [P1(x_{B}, y_{B}) and P2(x_{B}, y_{B})].

The controllable zone C is a zone in which a warning message is sent to a driver so that the driver can decelerate the vehicle. The size of the controllable zone C corresponds to a linear function between the average speed and the estimated duration time (T1) to warn a driver. Here the estimated duration time (T1) is expressed by the following equation 3.

Estimated Duration Time (T1) to Warn Driver=Communication Time (time of transmission and reception)+Information Processing Time of Vehicle Controller 200 and Internal Device 100+Duration Time for Driver to Perceive Warning+Safety Critical Time Equation 3

In Equation 3, the safety critical time corresponds to a predetermined time set by the vehicle controller 200.

For instance, the controllable zone C may be a zone which has the shape of a rectangular polygon and is defined by two points [P1(x_{C}, y_{C}) and P2(x_{C}, y_{C})].

After the service radius is classified into the plurality of zones, the vehicle controller 200 predicts the possibility of collision at collision zones at which the vehicles corresponding to vehicle information transmitted from the internal devices 100 of vehicles are located, and calculates information about the possibility of collision that corresponds to the predicted result (S440). Here, the information about the possibility of collision includes vehicle information (the identification (ID), the advancing direction, position, and speed of a vehicle 10), a collision zone, the distance between it and a vehicle to the rear, and an estimated time of collision (TTC).

Next, the vehicle controller 200 predetermines a priority of the target vehicle based on the estimated time of collision (S450). Here, the priority of the target vehicle is assigned such that the number of vehicles entering the central zone of the intersection is set to be different in conformity with the magnitude of the central zone of the intersection, and the number of priorities is assigned to coincide with the number of entering vehicles that was set.

The vehicle controller 200 transmits the control information about a vehicle corresponding to the vehicle information to the internal device 100 of a vehicle (S460). Here, the control information about a vehicle includes an ID of a vehicle, an expected entering time, a warning, or a control mode.

The internal device 100 of a vehicle determines whether to send a warning message to the driver of the vehicle, or to control the vehicle to be driven, based on the control information about the vehicle which was transmitted from the vehicle controller 200 (S470).

For instance, an internal device 100 of a vehicle provides a driver with a warning message, or controls the vehicle to travel when an ID of a vehicle included in the control information about a vehicle is the same as that of the vehicle in which the internal device 100 has been installed. Here, the internal device 100 provides the driver with an expected entering time, which is included in the control information about the vehicle, or controls the operation state of the vehicle such that the vehicle enters, at the expected entering time, the stop line of a first crosswalk at the intersection.

The internal device 100 of the vehicle checks whether the vehicle has entered the intersection, or not, based on the result of S470 (S480). If not, the internal device 100 transmits the vehicle information to the vehicle controller 200, and if so, that is, if the vehicle has escaped the intersection, the internal device terminates controlling the vehicle.

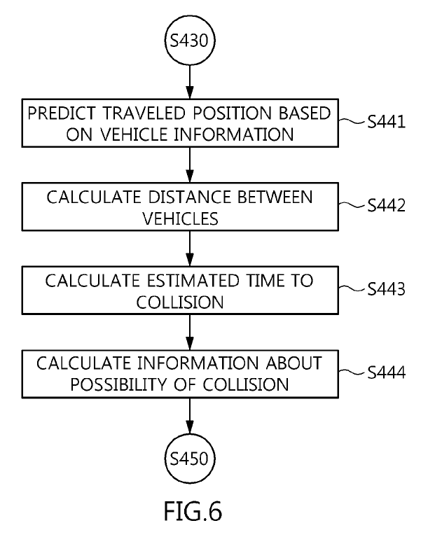

Next, a method (S440) of predicting a possibility of collision will be described in detail with reference to FIG. 6.

FIG. 6 is a flow chart showing a procedure of predicting a possibility of colliding of a target vehicle at the autonomous intersection according to an embodiment of the present invention.

Referring to FIG. 6, the vehicle controller 200 predicts the positions of vehicles at every user-setting time (e.g. 1, 2, 3 seconds) for vehicles and directions based on the vehicle information. Here, the vehicle information includes an ID, information about the advancing direction, position, and speed of a vehicle 10. Here, the information about the advancing direction may indicate e.g. at least one of an east-entering, west-entering, south-entering, and north-entering of a 4-way intersection. The vehicle controller can determine the advancing directions of vehicles (turning to the left or right, or driving straight), based on the information about the current driving direction and the direction of advance through an intersection.

That is, the vehicle controller 200 predicts the traveled positions of vehicles that are traveling using the current speed and the user-setting time among vehicle information by using equation 1 (S441).

Next, the vehicle controller 200 calculates the distance between a vehicle ahead and a vehicle behind depending on the difference in positions of vehicles in each direction (S442).

The vehicle controller 200 calculates the time taken from the traveled positions of vehicles that were calculated for vehicles and directions to the central zone of the intersection, i.e. the estimated time of collision (TTC) (S443). Here, the TTC is calculated based on the distance between the traveled position of a vehicle and the central zone of the intersection, and the speed of the target vehicle.

Like this, instead of managing traffic at an intersection using traffic signal management, the present invention can control the traffic at an intersection without using traffic lamps by means of the internal device 100 of a vehicle equipped with wireless communication means and the vehicle controller 200 capable of storing vehicle information.

As such, in the specification what has been described is the preferred embodiments of the invention. The terminology used herein is for the purpose of describing particular embodiments only and is not intended to limit the meaning or the scope of the invention described in the claims. Therefore, it will be apparent to those skilled in the art that a variety of modifications and equivalents can be made of the embodiments. Thus, the technical scope of the invention is defined by the accompanying claims.

What is claimed is:

1. An apparatus for controlling traffic at an autonomous intersection, the apparatus comprising:
a monitoring unit for monitoring vehicles located within a predetermined service radius of an intersection;
a collision zone information management unit for classifying a region within the service radius into a plurality of zones depending on a set reference based on the result provided by the monitoring unit, and managing information about collision zones corresponding to the plurality of classified zones;
a collision prediction unit for predicting a possibility of colliding of a target vehicle in a zone in which the target vehicle is located, based on vehicle information transmitted from the target vehicle located within the service radius, and calculating an estimated time of collision corresponding to the predicted result;
a priority determination unit for predetermining a priority of the target vehicle based on the estimated time of collision and calculating an expected entering time corresponding to the priority; and
a communication unit for transmitting control information about the target vehicle, including identifications, the expected entering time, a warning or a control mode corresponding to the expected entering time, to the target vehicle to control the target vehicle.

2. The apparatus according to claim 1, wherein the collision zone information management unit is configured to classify the service radius of the intersection into a central zone of the intersection, a proximal zone of the intersection, and a controllable zone, depending on the set reference corresponding to whether the vehicles passing through the intersection are able to be autonomously controlled or not.

3. The apparatus according to claim 2, wherein the central zone of the intersection is a zone through which vehicles in all directions of the intersection pass, the proximal zone of the intersection is a zone based on autonomous control of vehicles, and the controllable zone is a zone in which a warning message is transmitted to a driver to control a respective vehicle.

4. The apparatus according to claim 1, wherein the collision prediction unit is configured to estimate traveled positions of the target vehicle that are traveling using a current speed and a user set time among vehicle information and calculate a distance between a vehicle in front and a vehicle behind in each direction of the intersection depending on the difference in positions of vehicles so as to calculate the estimated time of collision given a distance from the traveled position to the central zone of the intersection.

5. The apparatus according to claim 4, wherein the estimated time of collision is calculated based on the distance between the traveled position and the central zone of the intersection among the plurality of zones, and a speed of the target vehicle.

6. The apparatus according to claim 1, wherein the priority determination unit is configured to set a number of vehicles entering the central zone of the intersection to be different in conformity with a magnitude of the central zone of the intersection among the plurality of zones and to assign the number of priorities corresponding to the number of the vehicles that was set.

7. The apparatus according to claim 1, wherein the communication unit is configured to transmit control information about the target vehicle to the target vehicle via wireless communication.

8. A method of controlling traffic at an autonomous intersection, the method comprising:
monitoring vehicles located within a predetermined service radius of an intersection;
classifying the service radius into a plurality of zones depending on a set reference based on the monitoring results, and managing information about collision zones corresponding to the plurality of classified zones;
predicting a possibility of colliding of a target vehicle in the zone in which the target vehicle is located, based on vehicle information transmitted from the target vehicle located within the service radius, and calculating an estimated time of collision corresponding to the predicted result;
predetermining a priority of the target vehicle based on the estimated time of collision and calculating an expected entering time corresponding to the priority; and
controlling the vehicles based on control information about the target vehicle, including identifications, the expected entering time, and a warning or a control mode corresponding to the expected entering time.

9. The method according to claim 8, wherein managing the information about the collision zones comprises classifying the service radius of the intersection into a central zone of the intersection, a proximal zone of the intersection, and a controllable zone, depending on the set reference corresponding to whether vehicles passing through the intersection are able to be autonomously controlled or not.

10. The method according to claim 9, wherein the central zone of the intersection is a zone through which vehicles in all directions of the intersection pass, the proximal zone of the intersection is a zone based on autonomous control of vehicles, and the controllable zone is a zone in which a warning message is transmitted to a driver to control a respective vehicle.

11. The method according to claim 8, wherein calculating the estimated time of collision comprises: estimating traveled positions of the target vehicle that are traveling using a current speed and a user set time among vehicle information; calculating a distance between a vehicle ahead and a vehicle behind in each direction of the intersection depending on the difference in positions of vehicles; and calculating the estimated time of collision given a distance between the traveled position and the central zone of the intersection.

12. The method according to claim 11, wherein the estimated time of collision is calculated based on the distance between the traveled position and the central zone of the intersection among the plurality of zones, and a speed of the target vehicle.

13. The method according to claim 11, wherein calculating the expected entering time comprises: setting a number of vehicles entering the central zone of the intersection to be different in conformity with a magnitude of the central zone of the intersection among the plurality of zones; and assigning the number of priorities corresponding to the number of the vehicles that was set.
